(19) United States
(12) Patent Application Publication
(10) Pub. No.: US 2026/0241409 A1
(43) Pub. Date: Aug. 20, 2026

(54) FULL COVER/FINE LINES SPRAY APPLICATION

(71) Applicant: Nordson Corporation, Westlake, OH (US)

(72) Inventors: Hubert KUFNER, Lüneburg (DE); Nicole SASSE, Lüneburg (DE); Timo MEYER, Lüneburg (DE)

(73) Assignee: Nordson Corporation, Westlake, OH (US)

(21) Appl. No.: 18/851,585

(22) PCT Filed: Mar. 27, 2023
(86) PCT No.: PCT/US2023/016361

§ 371 Date: Sep. 26, 2024

Related U.S. Application Data
(60) Provisional application No. 63/325,351, filed on Mar. 30, 2022.

(51) Int. Cl. B05C 5/02

(52) U.S. Cl. CPC B05C 5/0254

(57) ABSTRACT

An air shim plate with one or more air outlets that are configured to direct air to two or more adhesive filaments and/or have a width at least 1 millimeter (mm). For example, the air outlets may each have a width anywhere from 1 mm to 75 mm (e.g., in aggregate 1 or 2 mm wider than a corresponding one or more adhesive outlets). The air outlets may provide for a reduction or elimination of hammerheads, thereby resulting in more consistent adhesive application. The nozzle may include an adhesive shim that includes two or more adhesive outlets for application of the two or more adhesive filaments.

### CROSS REFERENCE TO RELATED APPLICATIONS

This application is a National Stage Application of International Patent App.

No. PCT/US 2023/016361, filed Mar. 27, 2023, which claims the benefit of U.S. Provisional Patent App. No. 63/325,351, filed Mar. 30, 2022, the entire disclosures of both of which are hereby incorporated by reference as if set forth in their entirety herein.

### TECHNICAL FIELD

The disclosure relates to generally to air-assisted nozzles and systems for extruding and moving filaments of viscous liquid in desired patterns and, more particularly, air-assisted dispensing of hot melt adhesive filaments.

### BACKGROUND

Various dispensing systems have been used in the past for applying patterns of viscous liquid material, such as hot melt adhesives, onto a moving substrate for a wide range of manufacturing purposes, including but not limit to packaging, assembly of various products, and construction of disposable absorbent hygiene products. Thus, the dispensing systems as described may be used in the production of disposable absorbent hygiene products such as diapers. In the production of disposable absorbent hygiene products, hot melt adhesive dispensing systems have been developed for applying a laminating or bonding layer of hot melt thermoplastic adhesive between a nonwoven fibrous layer and a thin polyethylene backsheet.

Typically, the hot melt adhesive dispensing system is mounted above a moving polyethylene backsheet layer and applies a uniform pattern of hot melt adhesive material across the upper surface width of the backsheet substrate. Downstream of the dispensing system, a nonwoven layer is laminated to the polyethylene layer through a pressure nip and then further processed into a final usable product.

In various hot melt adhesive dispensing systems, continuous filaments of adhesive are emitted from a plurality of adhesive outlets with plural process air jets oriented in various configurations adjacent a circumference of each adhesive outlet. The plural air jets discharge air in a converging, diverging, and/or parallel manner relative to the discharged adhesive filament or fiber as the filament emerges from the adhesive outlet. This process air can generally attenuate each adhesive filament and cause the filaments to move in overlapping or non-overlapping patterns before being deposited on the moving substrate.

Manufacturers in many fields, including manufacturers of disposable absorbent hygiene products, are interested in small fiber technology for the bonding layer of hot melt adhesive in nonwoven and polyethylene sheet laminates. To this end, hot melt adhesive dispensing systems have incorporated slot nozzle dies with a pair of air channels formed on each side of an elongated extrusion slot of the die. The air channels may be angled relative to the extrusion slot and arranged symmetrically so that curtains of pressurized air are emitted on opposite sides of the extrusion slot. Thus, as hot melt adhesive is discharged from the extrusion slot as a continuous sheet or curtain, the curtains of process air impinge upon and attenuate the adhesive curtain to form a uniform web of adhesive on the substrate.

Meltblown technology has also been adapted for use in this area to produce a hot melt adhesive bonding layer having fibers of relatively small diameter. Meltblown dies typically include a series of closely spaced adhesive nozzles or orifices that are aligned on a common axis across the die head. A pair of angled air channels or individual air passages and orifices may be positioned on both sides of the adhesive nozzles or orifices and aligned parallel to the common nozzle axis. As hot melt adhesive discharges from the series of aligned nozzles or orifices, pressurized air is discharged from the air channels or orifices to attenuate the adhesive fibers or filaments before they are applied to the moving substrate. The air may also cause the fibers to oscillate in a plane that is aligned with the movement of the substrate (i.e., in the machine direction) or in a plane that is aligned in the cross-machine direction.

One of the challenges associated with the above-described technologies relates to the production of fibrous adhesive layers during intermittent operations. More specifically, for some applications it is desirable to produce discrete patterns of fibrous adhesive layers rather than a continuous adhesive layer. Although some fibrous adhesive dispensers incorporate intermittent control of the adhesive and air flows to produce such discrete patterns, providing the discrete patterns with well-defined edges can be difficult to achieve.

For example, the velocity of the air directed at the adhesive must be sufficient to cleanly “break” the filaments when adhesive flow is stopped. Otherwise the filaments may continue to “string” along so that there is no clearly defined cut-off edge and cut-on edge between adjacent patterns deposited on the moving substrate. When high velocity air is used, however, the pattern of fibers between the cut-on and cut-off edges becomes more difficult to control. This is particularly true when high velocity air flows converge to impinge opposite sides the adhesive filaments. The filaments may end up breaking constantly during the dispensing cycle rather than merely at the starting and stopping points of the adhesive flow.

A related problem resulting from high velocity air directed in this manner is “fly,” which occurs when the adhesive gets blown away from the desired deposition pattern. The “fly” can be deposited either outside the desired edges of the pattern, or even build up on the dispensing equipment and cause operational problems that require significant maintenance. High velocity air, in combination with closely spaced nozzles, can also cause “shot” in which adjacent adhesive filaments become entangled and form globules of adhesive on the substrate. “Shot” is undesirable because it can cause heat distortion of delicate polyethylene backsheet substrates.

Additionally, hammerheads, resulting from variable pressure, may form. Thus, resulting in inconsistent pattern distribution.

### SUMMARY

The present application provides for an air shim plate with one or more air outlets that are configured to direct air to two or more adhesive filaments and/or have a width at least 1 millimeter (mm). For example, the air outlets may each have a width anywhere from 1 mm to 75 mm (e.g., in aggregate 1 or 2 mm wider than a corresponding one or more adhesive outlets). The air outlets may provide for a reduction or elimination of hammerheads, thereby resulting in more consistent adhesive application. The nozzle may include an adhesive shim that includes two or more adhesive outlets for application of the two or more adhesive filaments. In some embodiments, the adhesive shim includes one or more adhesive outlets that have a width greater than 1 mm. In aspects, the adhesive shim includes one or more adhesive outlets that have a width greater than 2 mm, 3 mm, 4 mm, 5 mm, 6 mm, 7 mm, 8 mm, 10 mm, 20 mm, 30 mm, 50 mm, 75 mm, and/or 100 mm. In aspects, the adhesive shim includes one or more adhesive outlets that have a width of 2 mm to 3 mm, 3 mm to 4 mm, 4 mm to 5 mm, 5 mm to 6 mm, 6 mm to 7 mm, 7 mm to 8 mm, 8 mm to 9 mm, 9 mm to 10 mm, 10 mm to 20 mm, 20 mm to 30 mm, 30 mm to 50 mm, or 50 mm to 100 mm.

According to an embodiment of the present disclosure, a nozzle for dispensing a pattern of liquid adhesive filaments may comprise a first air shim plate and an adhesive shim plate. The first air shim plate has one or more air slots that are configured to receive and direct pressurized air. The adhesive shim plate has at least two liquid slots configured to receive pressurized liquid adhesive and discharge liquid adhesive filaments, the pressurized air directed by the one or more air slots guides the filaments, of the pressurized liquid adhesive discharging from the at least two liquid slots, in a pattern. The one or more air slots of the first air shim plate are configured to direct the pressurized air along a first angle relative to the adhesive shim plate, such that when the at least two liquid slots discharge the liquid adhesive filaments, one of the one or more air slots is configured to direct the pressurized air to the liquid adhesive filaments discharged by the at least two liquid slots.

According to another embodiment of the present disclosure, a nozzle for dispensing a pattern of liquid adhesive filaments may include a first air shim plate and an adhesive shim plate. The first air shim plate has one or more air slots that are configured to receive and direct pressurized air. The adhesive shim plate has at least one liquid slot configured to receive pressurized liquid adhesive and discharge at least one liquid adhesive filament, the pressurized air directed by the one or more air slots guides the at least one liquid adhesive filament, of the pressurized liquid adhesive discharging from the at least one liquid slot, in a pattern. The one or more air slots of the first air shim plate are configured to direct the pressurized air along a first angle relative to the adhesive shim plate, such that when the at least one liquid slot discharges the at least one liquid adhesive filament, one of the one or more air slots is configured to direct the pressurized air to the at least one liquid adhesive filament discharged by the at least one liquid slot. Each of the one or more air slots of the first air shim plate have a respective air outlet that defines a width that is at least 1 mm.

### BRIEF DESCRIPTION OF THE DRAWINGS

The foregoing summary, as well as the following detailed description of illustrative embodiments of the nozzle of the present application, will be better understood when read in conjunction with the appended drawings. For the purposes of illustrating the nozzle of the present application, there is shown in the drawings illustrative embodiments. It should be understood, however, that the application is not limited to the precise arrangements and instrumentalities shown. In the drawings:

FIG. 1 is an assembled perspective view of one embodiment of a nozzle.

FIG. 2 is an exploded/disassembled side perspective view of the nozzle shown in FIG. 1, which includes a first air shim plate, an adhesive shim plate, and a second air shim plate.

FIG. 3 is a front elevational view of the first air shim plate of the nozzle of FIG. 1.

FIG. 4 is a front elevational view of a separating shim plate of the nozzle of FIG. 1.

FIG. 5 is a front elevational view of the adhesive shim plate of the nozzle of FIG. 1.

FIG. 6 is a cross sectional view taken along line 6 -6 illustrated in FIG. 1.

FIG. 7 is a cross sectional view taken along line 7 -7 illustrated in FIG. 1.

FIG. 8 is an enlarged view of the area bordered by a dashed dotted line in in FIG. 1.

FIG. 9 is an assembled bottom perspective view of the nozzle shown in FIG. 1.

FIG. 10 is an enlarged view of the area bordered by a dashed dotted line in FIG. 9.

FIG. 11 is a bottom view of the nozzle shown in FIG. 1.

FIG. 12 is a front elevational view of another embodiment of the adhesive shim plate of FIG. 5.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the scope of the present disclosure.

Also, as used in the specification including the appended claims, the singular forms “a,” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

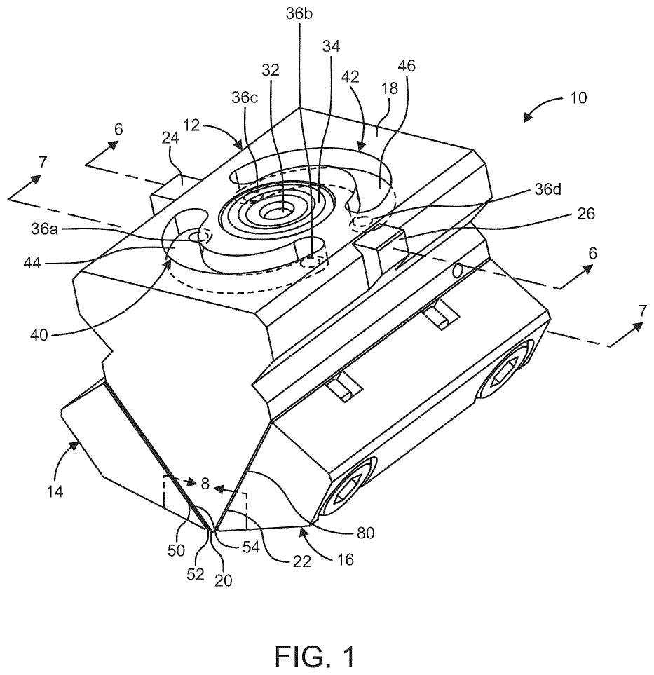

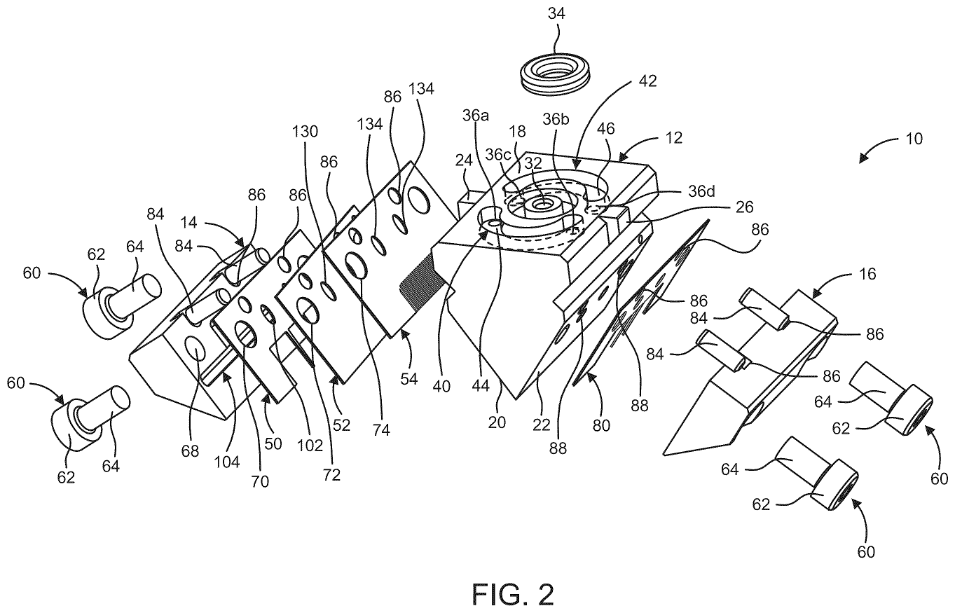

FIGS. 1 and 2 illustrate one embodiment of a nozzle 10 for dispensing a pattern of liquid adhesive filaments (not shown), such as a uniform pattern of hot melt adhesive material and/or the like. As will be described in greater detail below, the nozzle 10 may be constructed so that pressurized air, such as pressurized process air may be directed at the liquid adhesive filaments in an asymmetrical manner. This general principle may be incorporated into a wide variety adhesive dispensing systems. Thus, although the construction of the nozzle 10 will be described in detail, those of ordinary skill in the art will appreciate that the nozzle 10 is merely one example of how components may be arranged or a solid nozzle drilled or otherwise modified to achieve the arrangement described below.

The nozzle 10 may include a nozzle body 12 along with a first end plate 14 and a second end plate 16 that are secured to respective faces of the nozzle body 12. The nozzle body 12 may have a triangular, or wedge-shaped, cross-sectional configuration with a first surface 20 and a second surface 22 converging toward each other and a top surface 18 generally extending between the first surface 20 and the second surface 22. The nozzle 10 may include lateral projections 24, 26 on opposite sides of the top surface 18 and the lateral projections 24, 26 may secure the nozzle 10 to a dispensing valve, dispensing module, and/or the like (not shown), as further shown and described in U.S. Pat. No. 8,074,902 issued on Dec. 13, 2011 and entitled “Nozzle and method for dispensing random pattern of adhesive filaments,” and 6,676,038 issued Jan. 13, 2004 and entitled “Universal dispensing system for air assisted extrusion of liquid filaments,” the disclosures of both of which are incorporated herein by reference.

The nozzle body 12 may further include a liquid inlet 32 provided in the top surface 18 for receiving pressurized liquid adhesive when the nozzle 10 is secured to the dispensing valve, the dispensing module, and/or the like. A seal member 34 may be provided within and/or around the liquid inlet 32 to prevent leakage between these components. The top surface 18 may also have a plurality of implementations of process air inlets 36a, 36b, 36c, 36d (e.g., pressurized process air inlets) for receiving pressurized air. FIGS. 1 and 2 further illustrate the process air inlets 36a, 36b, 36c, 36d being formed in a first arcuate channel 40 or a second arcuate channel 42 on opposite sides of the liquid inlet 32. More specifically, a first process air inlet 36a and a second process air inlet 36b may be configured and arranged in a bottom surface 44 of the first arcuate channel 40, and a third process air inlet 36c and a fourth process air inlet 36d may be configured and arranged in a bottom surface 46 of the second arcuate channel 42.

The first arcuate channel 40 and/or the second arcuate channel 42 may help evenly distribute pressurized air directed at and/or provided to the top surface 18 to the respective implementations of the process air inlets 36a, 36b, 36c, 36d.

In one embodiment, the first end plate 14 may be secured to the first surface 20 of nozzle body 12 and the second end plate 16 may be secured to the second surface 22 of the nozzle body 12. Additionally, the nozzle 10 may include a first air shim plate 50, a separating shim plate 52, an adhesive shim plate 54, and/or the like that may be positioned between the first end plate 14 and the first surface 20. Although the first air shim plate 50 is described below serving to direct pressurized air, it will be appreciated that grooves (not shown) and/or the like may be provided in the first end plate 14 for this purpose in alternative embodiments.

The first air shim plate 50, the separating shim plate 52, and the adhesive shim plate 54 may be coupled to the first surface 20 so as to be arranged substantially parallel thereto. Threaded fasteners 60 may clamp the first air shim plate 50, the separating shim plate 52, and the adhesive shim plate 54 between the first end plate 14 and the first surface 20. To this end, as exemplified in FIG. 2, one or more of the threaded fasteners 60 may include an enlarged head 62 retained against the first end plate 14 and a threaded shaft 64 that extends through aligned holes 68, 70, 72, 74 of the first end plate 14, the first air shim plate 50, the separating shim plate 52, and the adhesive shim plate 54, respectively before engaging a tapped hole (not shown) in the first surface 20. However, the first end plate 14, the first air shim plate 50, the separating shim plate 52, and the adhesive shim plate 54 may be attached to the first surface 20 utilizing other components.

The second end plate 16 may be clamped or otherwise secured to the second surface 22 in substantially the same manner as the first end plate 14 and the first surface 20, but with a second air shim plate 80 positioned therebetween. However, the second end plate 16, the second air shim plate 80, and/or the like may be attached to the second surface 22 utilizing other components. Thus, the second air shim plate 80 may be coupled to the second surface 22 so as to be arranged substantially parallel thereto. The second air shim plate 80 is described below as serving to direct pressurized air, but, like the first end plate 14, the second end plate 16 may be provided with grooves (not shown) and/or the like for this purpose in alternative embodiments.

Thus, in some alternative embodiments, both the first end plate 14 and the second end plate 16 may direct pressurized air instead of the first shim plate 50 and the second air shim plate 80.

Referring still to FIG. 2, both the first end plate 14 and the second end plate 16 further may include a projection or locating members 84 that may facilitate properly positioning the first end plate 14 and the second end plate 16, the first shim plate 50, the second air shim plate 80, the separating shim plate 52, the adhesive shim plate 54, and/or the like relative to the nozzle body 12. To this end, the locating members 84 of the second end plate 16 may extend through respective upper slots or openings 86 in the second end plate 16 and the second air shim plate 80 before being received in a blind bore 88 in the second surface 22. Similarly, the locating members 84 of the first end plate 14 may be configured to extend through respective upper slots or openings 86 in the first end plate 14, the first air shim plate 50, the separating shim plate 52, and the adhesive shim plate 54 before being received in a respective implementation of the blind bore 88 in the first surface 20.

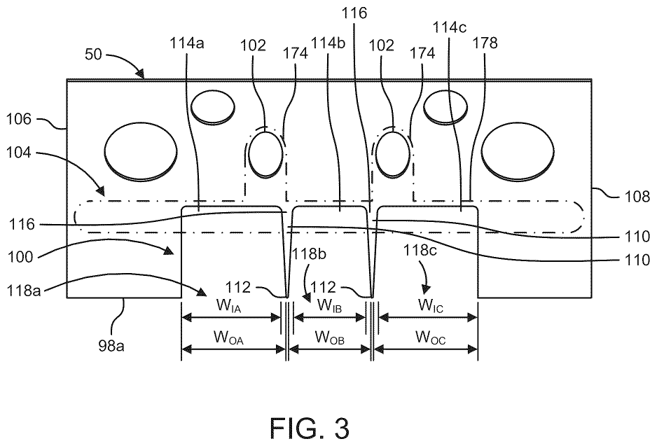

FIG. 3 illustrates the first air shim plate 50 in further detail. The first air shim plate 50 and the second air shim plate 80 (FIG. 2) may have substantially the same construction so as to be interchangeable, such that the following description applies equally to the second air shim plate 80. As shown in FIG. 3, the first air shim plate 50 may include a bottom edge 98a and a plurality of air slots 100 extending from the bottom edge 98a. The first air shim plate 50 may include holes 102 configured and arranged so that pressurized air can be directed from the nozzle body 12 to a distribution channel 104 in the first end plate 14 (FIG. 2). As will be described in greater detail below, the air slots 100 may be configured to receive and direct the pressurized air from the first end plate 14.

In one embodiment, the air slots 100 may be arranged between opposed ends 106, 108 of the first air shim plate 50. Adjacent implementations of the air slots 100 may converge toward each other as they extend toward the bottom edge 98a. For example, the first air shim plate 50 may include tapered members 110 that may be defined between each adjacent implementation of the air slots 100. The air slots 100 may include respective air inlets 114a, 114b, or 114c may be defined and/or may be located near a base portion 116 of the tapered members 110. The air slots 100 may each include a respective air outlet 118a, 118b, or 118c defined between the bottom edge 98a and terminating ends 112 of the associated tapered member 110 The air slots 100 may taper so that the respective widths are greater at the respective air inlets 114a, 114b, or 114c than at the respective air outlets 118a, 118b, or 118c. In some embodiments, the air slots 100 do not taper, thereby defining a width that is constant from the respective air outlet to the respective air inlet. Additionally, FIG. 3 illustrates a particular number of the air slots 100, the holes 102, the tapered members 110, and/or the terminating ends 112, however, the nozzle 10 may implement any number of the air slots 100, the holes 102, the tapered members 110, and/or the terminating ends 112.

The width W_{OA} of the respective air outlet 118 a may be 5.0 mm. In some embodiments, the width W_{OA} is greater than 1 mm. For example, the width W_{OA} may be anywhere from 1 mm to 20 mm. In aspects, the width W_{OA} may be 1 mm to 2 mm, 2 mm to 3 mm, 3 mm to 4 mm, 4 mm to 5 mm, 5 mm to 6 mm, or 6 mm to 7 mm. In an embodiment, the width W_{OA} is anywhere from 1 mm to 10 mm, 1 mm to 5 mm, or 1 mm to 2.5 mm.

The width W_{IA} of the respective air inlet 114 a may be 4.8 mm. In some embodiments, the width W_{IA} is greater than 1 mm. For example, the width W_{IA} may be anywhere from 1 mm to 20 mm. In aspects, the width W_{IA} may be 1 mm to 2 mm, 2 mm to 3 mm, 3 mm to 4 mm, 4 mm to 5 mm, 5 mm to 6 mm, or 6 mm to 7 mm. In an embodiment, the width W_{IA} is anywhere from 1 mm to 10 mm, 1 mm to 5 mm, or 1 mm to 2.5 mm.

The width W_{OB} of the respective air outlet 118b may be 3.9 mm. In some embodiments, the width W_{OB} is greater than 1 mm. For example, the width W_{OB} may be anywhere from 1 mm to 20 mm. The width W_{OB} may be different from the width W_{OA} so that the adjacent tapered members 110 are configured to overlap with a portion of the adhesive shim plate 54, as discussed below. In aspects, the width W_{OB} may be 1 mm to 2 mm, 2 mm to 3 mm, 3 mm to 4 mm, 4 mm to 5 mm, 5 mm to 6 mm, or 6 mm to 7 mm. In an embodiment, the width W_{OB} is 1 mm to 10 mm, 1 mm to 5 mm, or 1 mm to 2.5 mm.

The width W_{IB} of the respective air inlet 114b may be 3.5 mm. In some embodiments, the width W_{IB} is greater than 1 mm. For example, the width W_{IB} may be anywhere from 1 mm to 20 mm. The width W_{IB} may be different from the width W_{IA} so that the adjacent tapered members 110 are configured to overlap with a portion of the adhesive shim plate 54, as discussed below. In aspects, the width W_{IB} may be 1 mm to 2 mm, 2 mm to 3 mm, 3 mm to 4 mm, 4 mm to 5 mm, 5 mm to 6 mm, or 6 mm to 7 mm. In an embodiment, the width W_{IB} is anywhere from 1 mm to 10 mm, 1 mm to 5 mm, or 1 mm to 2.5 mm.

The width W_{OC} of the respective air outlet 118a may be 5.0 mm. In some embodiments, the width W_{OC} is greater than 1 mm. In aspects, the width W_{OC} may be 1 mm to 2 mm, 2 mm to 3 mm, 3 mm to 4 mm, 4 mm to 5 mm, 5 mm to 6 mm, or 6 mm to 7 mm. For example, the width W_{OC} may be anywhere from 1 mm to 20 mm. In an embodiment, the width W_{OC} is anywhere from 1 mm to 10 mm, 1 mm to 5 mm, or 1 mm to 2.5 mm.

The width W_{IC} of the respective air inlet 114a may be 4.8 mm. In some embodiments, the width W_{IC} is greater than 1 mm. For example, the width W_{IC} may be anywhere from 1 mm to 20 mm. In aspects, the width W_{IC} may be 1 mm to 2 mm, 2 mm to 3 mm, 3 mm to 4 mm, 4 mm to 5 mm, 5 mm to 6 mm, or 6 mm to 7 mm. In an embodiment, the width W_{IC} is anywhere from 1 mm to 10 mm, 1 mm to 5 mm, or 1 mm to 2.5 mm.

The tapered members 110 may be configured to support the separating shim plate 52 against bowing when dispensing high pressure material (e.g., the hot melt adhesive material). For example, the tapered members 110 may each be configured to abut both the separating shim plate 52 and the first end plate 14. The tapered members 110 may each be configured to overlap with a portion of the adhesive shim plate 54 that defines the distance Ds between adjacent liquid slots 136, thereby supporting the adhesive shim plate 54 (e.g., via the separating shim plate 52) against bowing when dispensing. In an alternative embodiment, some of the tapered members are not configured to overlap with the portion of the adhesive shim plate.

The terminating ends 112 of the tapered members 110 may extend slightly beyond a plane defined by the bottom edge 98a. For example, the terminating ends 112 may extend beyond the plane by anywhere from 0.01 mm to 1 mm, or 0.025 mm to 0.05 mm. In some embodiments, the terminating ends 112 may terminate at the plane defined by the bottom edge of the corresponding air shim. In an embodiment, the terminating ends 112 may be recessed from the plane defined by the bottom edge.

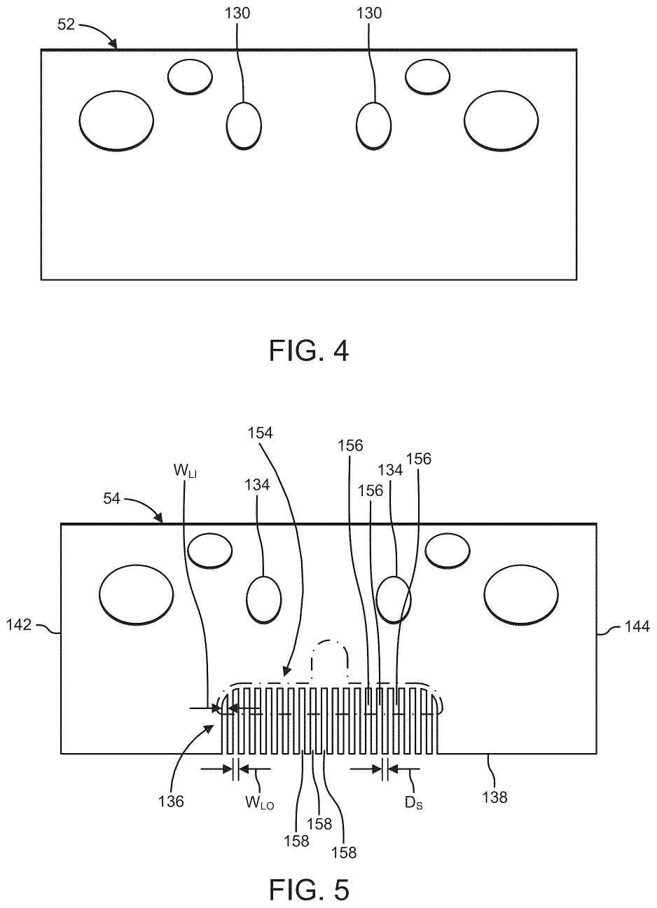

As shown in FIG. 4, the separating shim plate 52 may include holes 130 configured to be aligned with the holes 102 (FIG. 3) of the first air shim plate 50. The separating shim plate 52 may be rectangular and may serve as a spacer between the first air shim plate 50 and the adhesive shim plate 54. In some embodiments, more than one implementation of the separating shim plate 50 may be positioned between the first air shim plate 50 and the adhesive shim plate 54.

FIG. 5 illustrates the adhesive shim plate 54. Similar to the separating shim plate 52, the adhesive shim plate 54 may include holes 134 configured to be aligned with the holes 102 (FIG. 3) in the first air shim plate 50. The adhesive shim plate 54 may also include a plurality of liquid slots 136 extending from a bottom edge 138 between opposed ends 142, 144 of the adhesive shim plate 54.

The liquid slots 136 may be parallel with one another. For example, the liquid slots 136 may be spaced from each other an equal distance D_{S} (e.g., .26 mm). In aspects, the distance D_{S} may be 0.1 mm to 0.2 mm, 0.2 mm to 0.3 mm, 0.3 mm to 0.4 mm, 0.4 mm to 0.5 mm, or 0.5 mm to 0.6 mm. In some embodiments, the distance D_{S} is anywhere from 0.1 mm to 2 mm or 0.1 mm to 1 mm.

Each implementation of the liquid slot 136 may not vary in width along its length. For example, each implementation of the liquid slot 136 may include a respective liquid inlet 156 and a respective implementation of the liquid outlet 158. The liquid slots 136 may extend between associated implementations of the respective liquid inlets 156 and a respective implementation of the liquid outlets 158 with a constant width. Additionally, FIG. 5 illustrates a particular number of the liquid slots 136, the liquid outlets 158, and/or the liquid inlets 156, however, the nozzle 10 may implement any number of the liquid slots 136, the liquid outlets 158, and/or the liquid inlets 156.

For example, the respective liquid inlets 156 may each define a respective inlet width W_{LI} and the liquid outlets 158 may define a respective outlet width W_{LO} that may be the same as the inlet width W_{LI}. The width W_{LI} of the respective liquid inlet 156 may be 0.25 mm and the width W_{LO} of the respective implementation of the liquid outlet 158 may be 0.25 mm. In aspects, the width W_{LI} may be 0.1 mm to 0.2 mm, 0.2 mm to 0.3 mm, 0.3 mm to. 4 mm, 0.4 mm to 0.5 mm, or . 5 mm to 0.6 mm. In aspects, the width W_{LI} may be 0.1 mm to 0.2 mm, 0.2 mm to 0.3 mm, 0.3 mm to .4 mm, .4 mm to .5 mm, or .5 mm to .6 mm. In some embodiments, the width W_{LI} is anywhere from . 1 mm to 2 mm or. 1 mm to 1 mm. In some embodiments, the width W_{LO} is anywhere from. 1 mm to 2 mm or. 1 mm to 1 mm.

The width of every slot combined in aggregate may be 5 mm. In some embodiments, the width of every slot of the adhesive shim plate in aggregate is less than 5 mm, for example 1 mm. In some embodiments, the width of every slot of the adhesive shim plate in aggregate is more than 5 mm, for example 10 mm or 100 mm. In aspects, the width of every slot combined in aggregate may be 1 mm to 2 mm, 2 mm to 3 mm, 3 mm to 4 mm, 4 mm to 5 mm, 5 mm to 6 mm, 6 mm to 7 mm, 7 mm to 8 mm, 8 mm to 9 mm, 9 mm to 10 mm, 10 mm to 20 mm, 20 mm to 30 mm, 30 mm to 50 mm, or 50 mm to 100 mm.

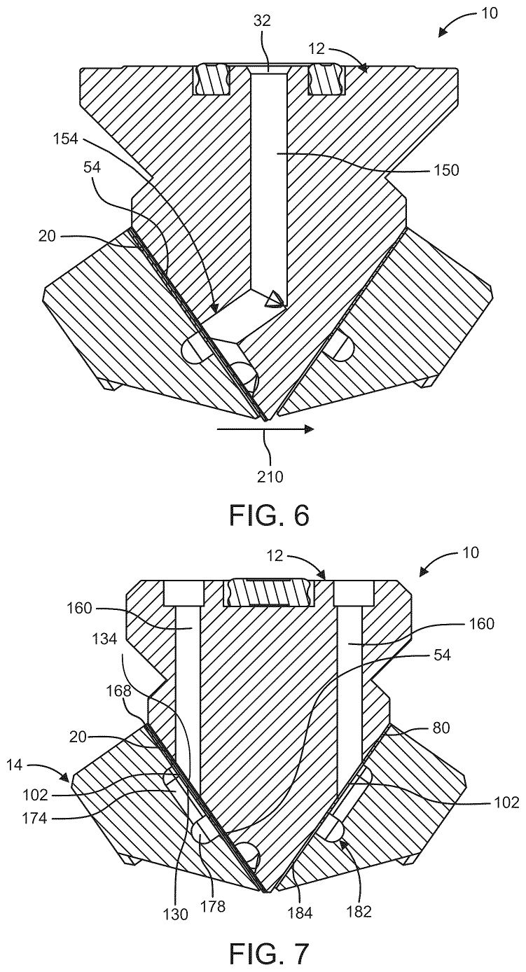

Now referring to FIGS. 5 and 6, the adhesive shim plate 54 may be configured to receive pressurized liquid adhesive from the nozzle body 12 when the nozzle 10 is assembled.

More specifically, the nozzle body 12 includes a liquid supply passage 150 (FIG. 5) that communicates pressurized liquid adhesive from the liquid inlet 32 to a distribution channel 154 (schematically shown in dashed dotted lines in FIG. 4) defined in the first surface 20.

Referring briefly to FIG. 4, a portion of the distribution channel 154 may extend across the first surface 20 proximate the respective liquid inlets 156 of the liquid slots 136. Thus, pressurized liquid adhesive communicated to the distribution channel 154 enters the liquid slots 136 through the respective liquid inlets 156 and is directed toward the bottom edge 138. The pressurized liquid adhesive is ultimately discharged from each implementation of the liquid slot 136 through the associated liquid outlet 158 as a filament of adhesive material.

Referring now to FIG. 7, the nozzle body 12 may include air supply passages 160 for directing pressurized air from respective implementations of the process air inlets 36a, 36b, 36c, 36d to the first surface 20 and the second surface 22. The nozzle body 12 may include a separate implementation of the air supply passage 160 for each process air inlet 36a, 36b, 36c, 36d. The air supply passages 160 may be configured to directed pressurized air through the holes 134 (FIGS. 2 and 5) in the adhesive shim plate 54. As a result, pressurized air communicated by the air supply passages 160 may flow through the holes 134 in the adhesive shim plate 54, the holes 130 in the separating shim plate 52, and the holes 102 in first air shim plate 50 before reaching the first end plate 14.

The first end plate 14 may include the distribution channel 104 (FIG. 2, and schematically shown in FIG. 3) formed on an inner surface 168 that confronts the first air shim plate 50. The distribution channel 104 is configured to direct the pressurized air to the respective air inlets 114a, 114b, and 114c (FIG. 3) of the air slots 100. The distribution channel 104 may include vertical recesses 174 aligned with the holes 102 and a horizontal recess 178 intersecting vertical recesses 174 and extending across the air inlets 114 of the air slots 100.

Pressurized air may be directed to, and distributed by, the second end plate 16 in a similar manner. For example, the air supply passages 160 may be fluidly connected with the process air inlets 36b, 36d and may direct the pressurized air to the holes 102 in the second air shim plate 80 so that the pressurized air can flow to a distribution channel 182 formed on an inner surface 184 of the second end plate 16. The distribution channel 182 may have a configuration similar to, or at least operating upon the same principles as, the distribution channel 104.

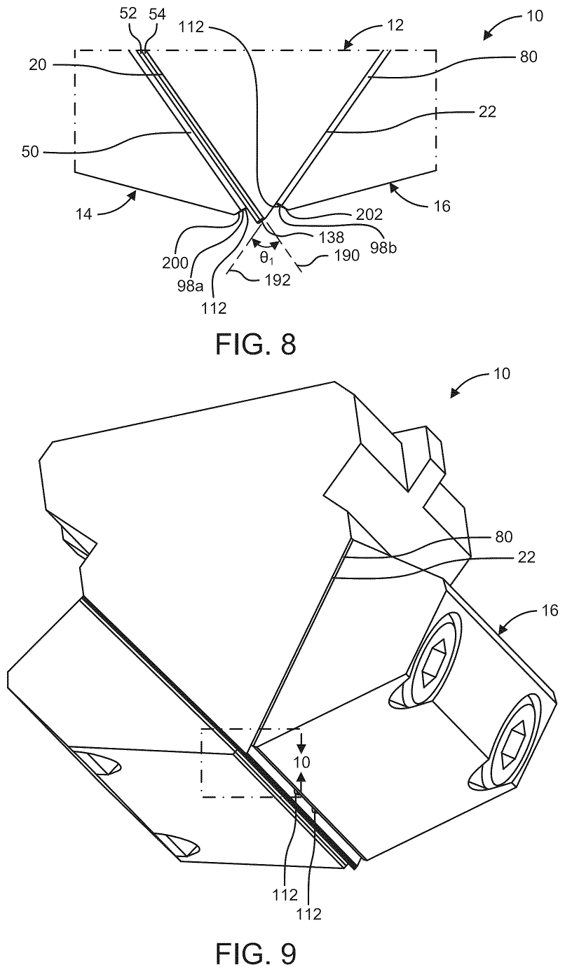

Now referring to FIGS. 7 and 8, in an assembled condition, the first surface 20 of nozzle body 12 defines a plane 190 and second surface 22 defines a plane 192 positioned at an angle θ₁ relative to the plane 190. Because the adhesive shim plate 54 is parallel to the first surface 20 (e.g., at an angle of 0°) and the second air shim plate 80 is parallel to the second surface 22, the second air shim plate 80 may be positioned at the angle θ₁ relative to adhesive shim plate 54. The angle θ₁ may be 70 degrees (°). In some embodiments, the angle θ₁ is anywhere from 40°to 90°.

FIGS. 7 and 8 also illustrate an example of relative positions of the adhesive shim plate 54, the first air shim plate 50, the second air shim plate 80, the first end plate 14, the second end plate 16, and/or the like when nozzle 10 is assembled. The first air shim plate 50 may extend flush with the first end plate 14 such that the associated bottom edge 98a is not spaced from a bottom edge 200 of the first end plate 14.

The bottom edge 138 of the adhesive shim plate 54 may protrude beyond the bottom edge 98. For example, the bottom edge 138 may protrude anywhere from 0.1 mm to 2 mm or 0.1 mm to 1 mm beyond the bottom edge 98. Protrusion of the bottom edge 138 beyond the bottom edge 98 may provide for a reduction of air speed by allowing air from the from the air outlets 118a, 118b, and 118c to expand. The reduction of air speed may provide for the air catching adhesive fibers more effectively.

Similarly, the second air shim plate 80 may extend flush with the second end plate 16 such that the associated bottom edge 98b is not spaced from a bottom edge 202 of the second end plate 16.

The bottom edges 200, 202 may extend across portions of the air slots 100 (FIG. 3) in associated implementations of the first air shim plate 50 and the second air shim plate 80.

The position of the bottom edges 200, 202 may approximately correspond to the terminating ends 112 of the tapered members 110.

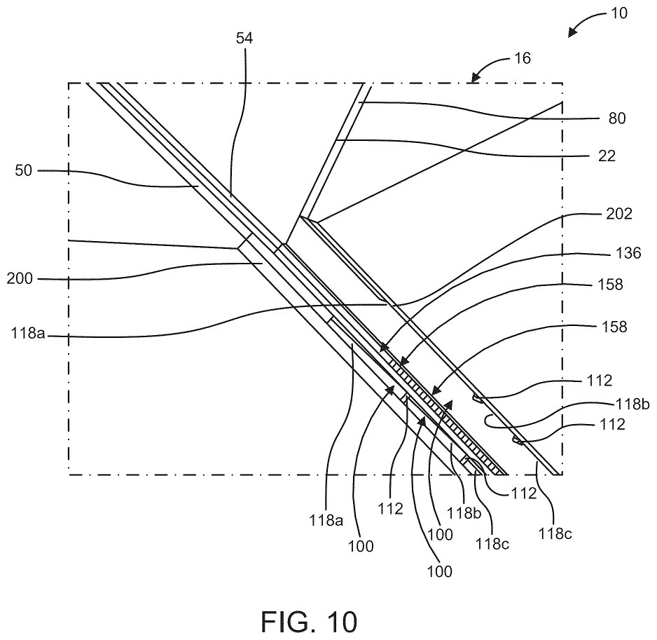

As shown in FIGS. 9 and 10, the second air shim plate 80 may be positioned between the second surface 22 and the second end plate 16 such that the terminating ends 112 extend slightly beyond the bottom edge 202. The first air shim plate 50 and the first end plate 14 may be arranged in a similar manner.

For example, the terminating ends 112 may project slightly beyond the bottom edge 200. For example, the terminating ends 112 may project anywhere from 0.1 mm to 2 mm or 0.1 mm to 1 mm beyond the bottom edge 200. In an embodiment, the terminating ends 112 may be flush with or recessed from the bottom edge of the corresponding air shim plate. For example, the terminating tends may recede slightly from the bottom edge 200 (e.g., anywhere from. 1 mm to 2 mm or 0.1 mm to 1 mm) Each implementation of the air slot 100 may define an air passage extending from the respective air inlet 114a, 114b, or 114c (FIG. 3) to the respective air outlet 118a, 118b, or 118c for directing pressurized air toward one or more of the liquid outlets 158 and/or the filaments dispensed by the liquid outlets 158.

In an embodiment, one or both of the first air shim plate 50 and the second air shim plate 80 may be positioned so that their associated bottom edge may be substantially flush with bottom edge of the first end plate 14 or bottom edge of the second end plate 16. In aspects, the first air shim plate 50 and the second air shim plate 80 may also be configured so that the terminating ends of the tapered members 110 may be substantially aligned with the associated bottom edge in the plane defined by the corresponding bottom edge (FIG. 3).

Referring again to FIG. 10, the adhesive shim plate 54 may be positioned so that multiple of the liquid slots 136 are arranged between a single implementation of the air slot 100 of the first air shim plate 50 and a single implementation of the air slot 100 of the second air shim plate 80. As a result, only a single implementation of the air slot 100 of the first air shim plate 50 is configured to provide pressurized air to multiple liquid slots 136 and/or the filaments dispensed by the liquid slots 136. Also, only a single implementation of the air slot 100 of the second air shim plate 80 is configured to provide pressurized air to multiple liquid slots 136 and/or the filaments dispensed by the liquid slots 136.

A pair of opposing implementations of the air slots 100 (e.g., one implementation of the air slot 100 of the first air shim plate 50 and one implementation of the air slot 100 of the second air shim plate 80) may be configured to provide pressurized air to the same implementation of the liquid slots 136 and/or the filaments dispensed by such implementations of the liquid slots 136.

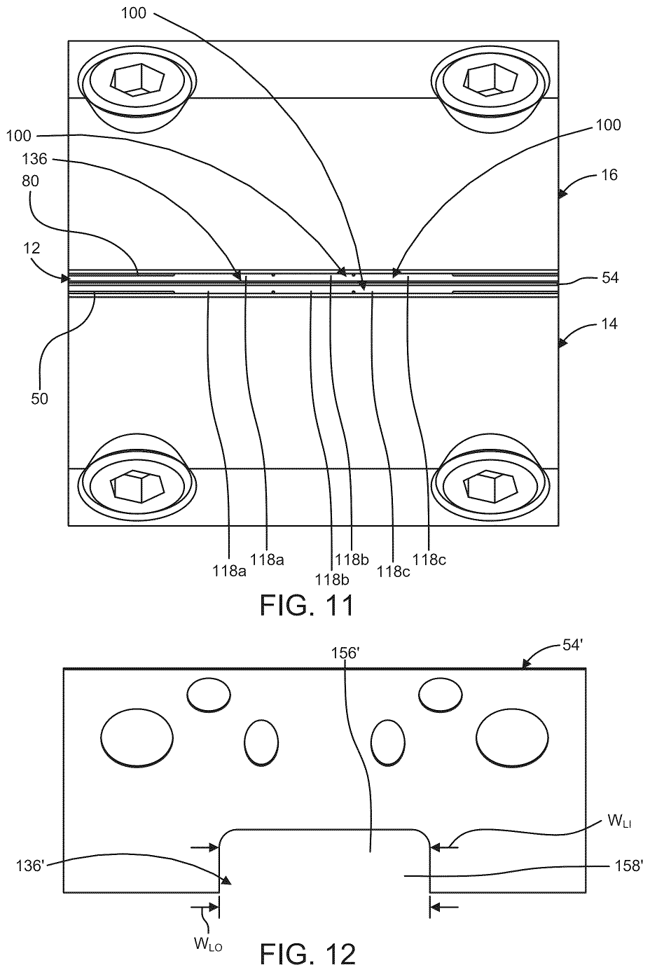

FIG. 11 illustrates a bottom of the nozzle 10, in which the first end plate 14 and the second end plate 16 are opposite one another relative to the nozzle body 12. The respective air outlets 118a, 118b, and 118c are illustrated on either side of the corresponding implementation of the liquid slots 136. During a dispensing operation, pressurized liquid adhesive is supplied to the respective liquid inlets 156 of the liquid slots 136 in the adhesive shim plate 54 as described above. The liquid slots 136 may be configured to discharge the pressurized liquid adhesive through the liquid outlets 158 (FIG. 10) as adhesive filaments. The adhesive filaments may be discharged at a slight angle in a machine direction 210 (FIG. 6) of a substrate (not shown) moving past the nozzle 10 due to the arrangement of the nozzle 10 relative to the machine direction 210. At the same time, pressurized air is supplied to the air inlets 114 (FIG. 3) of the air slots 100 in the first air shim plate 50 and the second air shim plate 80. The air passages defined by the air slots 100 may direct the pressurized air toward the adhesive filaments being discharged from the liquid slots 136.

Each pair of opposing implementations of the air slots 100 may provide a uniform pressure zone that may guide the filaments in a consistent and/or uniform manner. For example, the adhesive filaments may be guided by the pressure zone toward the substrate without moving back and forth in a “web-direction” (i.e., substantially parallel to the machine direction 210), and without moving back and forth in a “cross-web” direction (i.e., substantially perpendicular to the machine direction 210). As such, the adhesive filaments may be deposited on the substrate in a consistent and/or uniform pattern generally along the machine direction 210. For example, to the naked eye the pattern may appear consistent and/or uniform, whereas when examined under a microscope, the pattern may appear as a random fiber pattern with multiple small fibers. In this regard, the disclosed configuration of the nozzle 10 provided these unexpected results.

Directing pressurized air toward the adhesive filaments with the above described implementation of the air slots 100, the nozzle 10, and/or the like can provide for improved intermittent performance and reduced hammerhead (e.g., by about 30%), which can be inversely correlated with air flow through the air slots 100. For example, the air slots 100 having a width greater than 1 mm may provide for the pressurized air to guide the adhesive filaments, thereby reducing deviation from a desired adhesive pattern to be applied. The air flow can be reduced, which may result in more random fibers. When the air flow is maintained at a high level, the air may cut the adhesive fibers in small pieces for dotted application. For example, the air curtain produced by the air slots 100 may encourage the adhesive fibers to split into more pieces. In this regard, the disclosed configuration of the nozzle 10 provided these unexpected results.

During an intermittent stoppage, the air slots 100 may receive the pressurized air at an increased pressure and/or velocity to effectively “break” the adhesive filaments between dispensing cycles to provide the deposited pattern with well-defined cut-off and cut-on edges. In this regard, the disclosed configuration of the nozzle 10 provided these unexpected results.

During dispensing cycles, the pressurized air may be at a lower pressure and/or velocity compared to the intermittent stoppage.

The arrangement of the second air shim plate 80 relative to the adhesive shim plate 54 may provide for well-defined cut-off and cut-on edges. For example, the second air shim plate 80 may be configured to direct pressurized air to immediately adjacent implementations of the liquid outlets 158 (FIG. 5) because of angle θ₁ (FIG. 8) and the proximity of the bottom edge 98b to the bottom edge 138. This arrangement may allow the pressurized air to strike the adhesive filaments as soon as they are discharged from the liquid outlets 158. In this regard, the disclosed configuration of the nozzle 10 provided these unexpected results.

Referring now to FIG. 12, a second embodiment of the adhesive shim plate 54′ is shown. It is to be appreciated that the second embodiment can be similar to the first embodiment of the adhesive shim plate 54 shown in FIG. 5, for example. Accordingly, the same reference numbers used above with reference to the first embodiment can be also used with a “prime” notation in reference to a second embodiment. It is also to be appreciated that, unless otherwise set forth below, the components (and features thereof) of the adhesive shim plate 54′ of the second embodiment can be similar to those of the adhesive shim plate 54 of the first embodiment.

The adhesive shim plate 54′ may define a single liquid slot 136′ that defines a single liquid inlet 156′ and a single liquid outlet 158′. The liquid inlet 156′ may define an inlet width W_{LI} and the liquid outlet 158′ may define an outlet width W_{LO} that may be the same as the inlet width W_{LI}. The width W_{LI} of liquid inlet 156′ may be 10 mm and the width W_{LO} of the liquid outlet 158′ may be 10 mm. In aspects, the outlet width W_{LO} may be 6 mm to 7 mm, 7 mm to 8 mm, 8 mm to 9 mm, 9 mm to 10 mm, 10 mm to 12 mm, or 12 mm to 14 mm. In aspects, the inlet width W_{LI} may be 6 mm to 7 mm, 7 mm to 8 mm, 8 mm to 9 mm, 9 mm to 10 mm, 10 mm to 12 mm, or 12 mm to 14 mm. In some embodiments, the width W_{LI} is anywhere from 10 mm to 20 mm, 20 mm to 30 mm, 30 mm to 50 mm, or 50 mm to 100 mm. In some embodiments, the width W_{LO} is anywhere from 10 mm to 20 mm, 20 mm to 30 mm, 30 mm to 50 mm, or 50 mm to 100 mm.

The liquid outlet 158′ may be configured to provide a single adhesive filament that has a width that is the same (or within 1%, 2%, 3% 4%, or 5% of) the width W_{LO} when dispensed on the substrate. When the nozzle 10 is assembled with the adhesive shim plate 54′ in place of the adhesive shim plate 54 (e.g., in FIG. 6), each pair of opposing implementations of the air slots 100 (e.g., as shown in FIG. 10) may provide a uniform pressure zone that may guide the single adhesive filament in a consistent and/or uniform manner. For example, the adhesive filament may be guided by the pressure zone toward the substrate without moving back and forth in the “web-direction,” and without moving back and forth in the “cross-web” direction. As such, the single adhesive filament may be deposited on the substrate in a consistent and/or uniform pattern generally along the machine direction 210. In this regard, the disclosed configuration of the nozzle 10 provided these unexpected results.

Directing pressurized air toward the single adhesive filament with the above described air slots 100, the nozzle 10 can provide for improved intermittent performance and reduced hammerhead. For example, the air slots 100 having a width greater than 1 mm may provide for the pressurized air to guide the adhesive filament, thereby reducing deviation from a desired adhesive pattern to be applied. In this regard, the disclosed configuration of the nozzle 10 provided these unexpected results.

Certain terminology is used in the following description for convenience only and is not limiting. The words “right”, “left”, “lower” and “upper” designate directions in the drawings to which reference is made. The words “inner”, “internal”, and “interior” refer to directions towards the geometric center of the nozzle 10, while the words “outer”, “external”, and “exterior” refer to directions away from the geometric center of the nozzle. The terminology includes the above-listed words, derivatives thereof and words of similar import.

Although the disclosure has been described in detail, it should be understood that various changes, substitutions, and alterations can be made herein without departing from the spirit and scope of the disclosure as defined by the appended claims. Additionally, any of the embodiments disclosed herein can incorporate features disclosed with respect to any of the other embodiments disclosed herein. Moreover, the scope of the present disclosure is not intended to be limited to the particular embodiments described in the specification. As one of ordinary skill in the art will readily appreciate from that processes, machines, manufacture, composition of matter, means, methods, or steps, presently existing or later to be developed that perform substantially the same function or achieve substantially the same result as the corresponding embodiments described herein may be utilized according to the present disclosure.

For example, although FIG. 6 illustrates one arrangement of nozzle 10 relative to the machine direction 210, the nozzle 10 could alternatively be arranged so that the machine direction 210 is in an opposite direction (e.g., from right to left in FIG. 6). In such an embodiment, the adhesive shim plate 54 discharges the adhesive filaments at a slight angle against the machine direction. The various aspects and features described herein may be used alone or in any combination depending on the needs of the user. The disclosure in its broader aspects is therefore not limited to the specific details, representative apparatus and methods and illustrative examples shown and described. Accordingly, departures may be made from such details without departing from the scope or spirit of the general inventive concept.

1. A nozzle for dispensing a pattern of liquid adhesive filaments, comprising:
a first air shim plate that has one or more air slots that are configured to receive and direct pressurized air; and
an adhesive shim plate that has at least two liquid slots configured to receive pressurized liquid adhesive and discharge liquid adhesive filaments, the pressurized air directed by the one or more air slots guides the filaments, of the pressurized liquid adhesive discharging from the at least two liquid slots, in a pattern,
wherein the one or more air slots of the first air shim plate are configured to direct the pressurized air along a first angle relative to the adhesive shim plate, such that when the at least two liquid slots discharge the liquid adhesive filaments, one of the one or more air slots is configured to direct the pressurized air to the liquid adhesive filaments discharged by the at least two liquid slots.

2. The nozzle of claim 1, wherein the one or more air slots of the first air shim plate are configured to direct the pressurized air to guide the filaments of the pressurized liquid adhesive discharging from the liquid slots in the pattern.

3. The nozzle of claim 1, wherein the pattern is predetermined.

4. The nozzle of claim 1, wherein each of the one or more air slots of the first air shim plate have a respective air outlet that defines a width that is anywhere from 1 mm to 10 mm.

5. The nozzle of claim 4, wherein each width of the respective air outlet is anywhere from 1 mm to 2.5 mm.

6. The nozzle of claim 1, wherein each one of the at least two liquid slots has a respective liquid outlet that defines a width that is anywhere from 0.1 mm to 2 mm.

7. (canceled)

8. The nozzle of claim 1, further comprising:
a separating shim plate positioned between the first air shim plate and the adhesive shim plate.

9. The nozzle of claim 1, wherein the at least two liquid slots are configured to discharge the liquid adhesive filaments parallel to one another.

10. The nozzle of claim 1, wherein the at least two liquid slots are at least five liquid slots that are configured to receive the pressurized liquid adhesive and discharge the liquid adhesive filaments, and
wherein the one of the one or more air slots is configured to direct the pressurized air to the liquid adhesive filaments that are discharged by the at least five liquid slots.

11. The nozzle of claim 1, further comprising:
a second air shim plate, wherein the second air shim plate has one or more air slots that are configured to receive and direct pressurized air, wherein the one or more air slots of the second air shim plate are configured to direct the pressurized air along a second angle relative to the adhesive shim plate, the first angle being different than the second angle so that the first and second air shim plates direct the pressurized air asymmetrically toward the adhesive filaments, and
wherein the adhesive shim plate is positioned between the first and second air shim plates.

12. The nozzle of claim 11, wherein the first angle is 0° and the second angle is anywhere from 40° to 90°.

13. The nozzle of claim 11, further comprising:
a nozzle body, the first and second air shim plates and the adhesive shim plate being coupled to the nozzle body;
a first end plate secured to the first surface of the nozzle body, the first air shim plate and the adhesive shim plate being positioned between the first end plate and the nozzle body; and
a second end plate secured to the second surface of the nozzle body, the second air shim plate being positioned between the second end plate and the nozzle body,
wherein the at least two liquid slots are at least five liquid slots that are configured to receive the pressurized liquid adhesive and discharge the liquid adhesive filaments,
wherein the one of the one or more air slots of each of the first air shim plate and the second air shim plate are configured to direct the pressurized air to the liquid adhesive filaments that are discharged by the at least five liquid slots, and
wherein each of the liquid slots is arranged between the one of the one or more air slots of each of the first air shim plate and the second air shim plate.

14-15. (canceled)

16. A nozzle for dispensing a pattern of liquid adhesive filaments, comprising:
a first air shim plate that has one or more air slots that are configured to receive and direct pressurized air; and
an adhesive shim plate that has at least one liquid slot configured to receive pressurized liquid adhesive and discharge at least one liquid adhesive filament, the pressurized air directed by the one or more air slots guides the at least one liquid adhesive filament, of the pressurized liquid adhesive discharging from the at least one liquid slot, in a pattern,
wherein the one or more air slots of the first air shim plate are configured to direct the pressurized air along a first angle relative to the adhesive shim plate, such that when the at least one liquid slot discharges the at least one liquid adhesive filament, one of the one or more air slots is configured to direct the pressurized air to the at least one liquid adhesive filament discharged by the at least one liquid slot; and
wherein each of the one or more air slots of the first air shim plate have a respective air outlet that defines a width that is at least 1 mm.

17. The nozzle of claim 16, wherein each width of the respective air outlet is anywhere from 1 mm to 10 mm.

18. The nozzle of claim 17, wherein each width of the respective air outlet is anywhere from 1 mm to 2.5 mm.

19. The nozzle of claim 1, wherein each one of the at least one liquid slot has a respective liquid outlet that defines a width that is anywhere from 0.1 mm to 2 mm.

20. The nozzle of claim 19, wherein each width of the respective liquid outlet is anywhere from 0.1 mm to 1 mm.

21. The nozzle of claim 16, wherein the at least one liquid slot is a single liquid slot and the at least one liquid adhesive filament is a single adhesive filament, or wherein the one or more air slots are three or more air slots.

22. (canceled)

23. The nozzle of claim 16, further comprising:
a second air shim plate, wherein the second air shim plate has one or more air slots that are configured to receive and direct pressurized air, wherein the one or more air slots of the second air shim plate are configured to direct the pressurized air along a second angle relative to the adhesive shim plate, the first angle being different than the second angle so that the first and second air shim plates direct the pressurized air asymmetrically toward the at least one liquid adhesive filament,
wherein the adhesive shim plate is positioned between the first air shim plate and the second air shim plate.

24. The nozzle of claim 23, wherein the first angle is 0° and the second angle is anywhere from 40° to 90°.

25. (canceled)
